(19) United States
(12) Patent Application Publication
(10) Pub. No.: US 2020/0365849 A1
(43) Pub. Date: Nov. 19, 2020

(54) BATTERY MODULE ASSEMBLY AND METHOD OF MANUFACTURING THE SAME

(71) Applicant: HYUNDAI MOBIS Co., Ltd., Yongin-si (KR)

(72) Inventor: Yun Su Park, Yongin-si (KR)

(21) Appl. No.: 16/867,927

(22) Filed: May 6, 2020

(30) Foreign Application Priority Data
May 13, 2019 (KR) 10-2019-0055704

(51) Int. Cl. H01M 2/10; H01M 2/04; H01M 2/26; H01M 10/613

(52) U.S. Cl. CPC H01M 2/1077; H01M 2/1083; H01M 2220/20; H01M 2/266; H01M 10/613; H01M 2/043

(57) ABSTRACT

A battery module assembly includes a plurality of cells, a plurality of cartridges stacked in a vertical direction with a corresponding cell therebetween, and a caulking pipe inserted into a through-hole provided in a corner of each of the stacked plurality of cartridges, for assembling the stacked plurality of cartridges.

### CROSS-REFERENCE TO RELATED APPLICATION

This application claims priority from and the benefit of Korean Patent Application No. 10-2019-0055704, filed on May 13, 2019, which is hereby incorporated by reference for all purposes as if fully set forth herein.

### BACKGROUND

### Field

Exemplary embodiments of the invention relate to a battery module assembly applied to vehicles.

### Discussion of the Background

FIG. 1 is an exploded perspective view of a related art battery module assembly 100.

Referring to FIG. 1, the related art battery module assembly 100 includes a plurality of pouch-type battery cells 200, a cell cover 310 which surrounds entire outer surfaces of a pair of battery cells (two battery cells) or three or more battery cells, and an upper frame member 400 and a lower frame member 500, which are vertically detached from each other and are coupled to each other in an assembly fastening structure.

In FIG. 1, reference numeral 223 refers to an electrode terminal, and reference numerals 600 and 601 refer to bus bars. Descriptions of the other reference numerals are omitted.

The related art battery module assembly 100 has the following problems.

First, a forming structure is processed to surround a pair of battery cells (two battery cells) or three or more battery cells, and in this case, a cell cover 310 may use a thin aluminum material so as to permit a decrease in size thereof. Use of the aluminum material in the cell cover 310 results in a high probability of damage to the insulating properties of the cell cover 310 by water penetration.

Second, although not shown in detail, an insert nut structure (an assembly structure) for assembling an upper detachable frame and a lower detachable frame and an insert bolt structure (a mounting structure) for mounting a battery module on an inner portion of a vehicle are needed, a battery module size increases and the number of elements increases.

Third, a lower frame member 500 is manufactured by an injection process, but a limitation of the injection process causes a phenomenon (a rib bending phenomenon) where a vertical partition wall part (rib) configuring like a direction of a dotted arrow illustrated in FIG. 1.

Therefore, in order to easily insert the cell cover surrounding the battery cells into the lower frame member 500, a worker should perform a handwork of unfolding a partition wall part with hands several to tens times before working, and the handwork increases an assembly cycle time (an assembly process time).

The above information disclosed in this Background section is only for understanding of the background of the inventive concepts, and, therefore, it may contain information that does not constitute prior art.

### SUMMARY

Exemplary embodiments of the present invention provide a battery module assembly and a method of manufacturing the same, which decrease a size of the battery module assembly and the number of elements, and simultaneously reduce an assembly cycle time of the battery module assembly.

Additional features of the invention will be set forth in the description which follows, and in part will be apparent from the description, or may be learned by practice of the invention.

An exemplary embodiment of the inventionprovides a battery module assembly including: a plurality of cells; a plurality of cartridges stacked in a vertical direction with a corresponding cell therebetween; and a caulking pipe inserted into a through-hole provided in a corner of each of the stacked plurality of cartridges, for assembling the stacked plurality of cartridges.

Another exemplary embodiment of the invention provides a battery module assembly including: a plurality of cells; a plurality of cartridges stacked in a vertical direction with a corresponding cell therebetween; a caulking pipe inserted into a through-hole provided in a corner of each of the stacked plurality of cartridges to bind the stacked plurality of cartridges in a horizontal direction and the vertical direction; and a coupling member coupled to a side surface of each of the stacked plurality of cartridges to bind the stacked plurality of cartridges in the vertical direction.

Another exemplary embodiment of the invention provides a method of manufacturing a battery module assembly including: stacking a plurality of cartridges in a vertical direction with a corresponding cell therebetween; inserting a caulking pipe into a through-hole provided in a corner of each of the stacked plurality of cartridges to bind the stacked plurality of cartridges in a horizontal direction and the vertical direction; and fastening a side surface of each of the stacked plurality of cartridges to a coupling member for binding the stacked plurality of cartridges in the vertical direction.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a battery module assembly of the related art.

FIG. 2 is an exploded perspective view of a battery module assembly according to an exemplary embodiment of the present invention.

FIG. 3 is a perspective view illustrating a state where elements illustrated in FIG. 2 are assembled.

FIG. 4 is a perspective view illustrating elements for binding a plurality of stacked elements in a state where the elements illustrated in FIG. 2 are stacked.

FIG. 5 is a perspective view illustrating a final appearance of a battery module assembly assembled by elements illustrated in FIG. 4.

FIG. 6 is an enlarged view of a caulking pipe illustrated in FIG. 4.

FIGS. 7(A), 7(B), 7(C), and 7(D) are diagrams schematically illustrating an assembly process of a battery module assembly based on the caulking pipe illustrated in FIG. 6.

FIG. 8 is an enlarged view of a coupling member illustrated in FIG. 4.

FIG. 9 is a perspective view illustrating an inner surface and an outer surface of an upper cartridge illustrated in FIG. 2.

FIG. 10 is a perspective view illustrating an inner surface and an outer surface of a lower cartridge illustrated in FIG. 2.

FIGS. 11A and 11B are plan views illustrating a shape where a cartridge A is stacked on an upper/lower cartridge illustrated in FIGS. 9 and 10.

FIG. 12 is an enlarged view of a cartridge A illustrated in FIG. 2.

FIG. 13 is an enlarged view of a cartridge C illustrated in FIG. 2.

FIG. 14 is an enlarged view of a cartridge B illustrated in FIG. 2.

FIGS. 15, 16, and 17 are diagrams for describing a structure where a battery module assembly according to an exemplary embodiment of the present invention is mounted on a case.

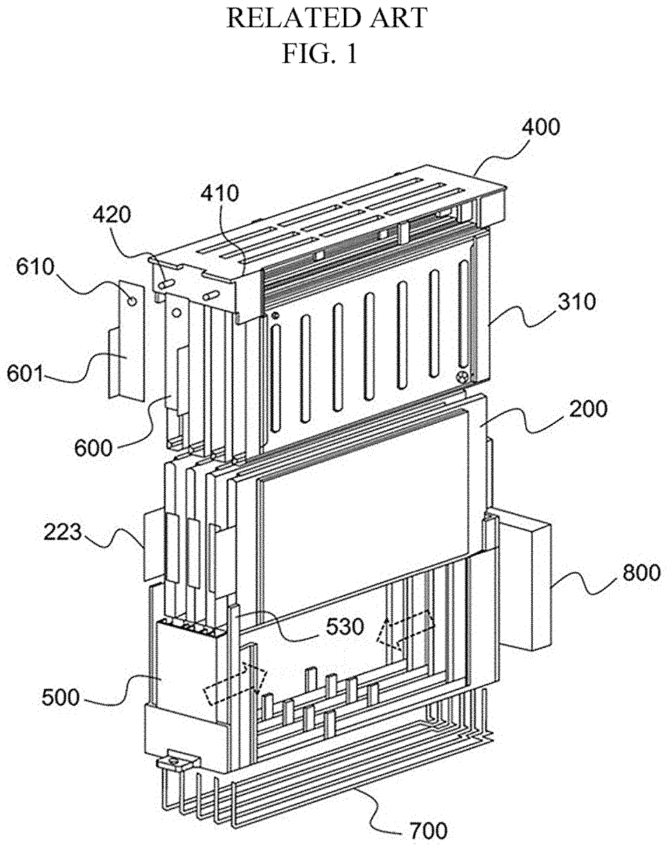

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

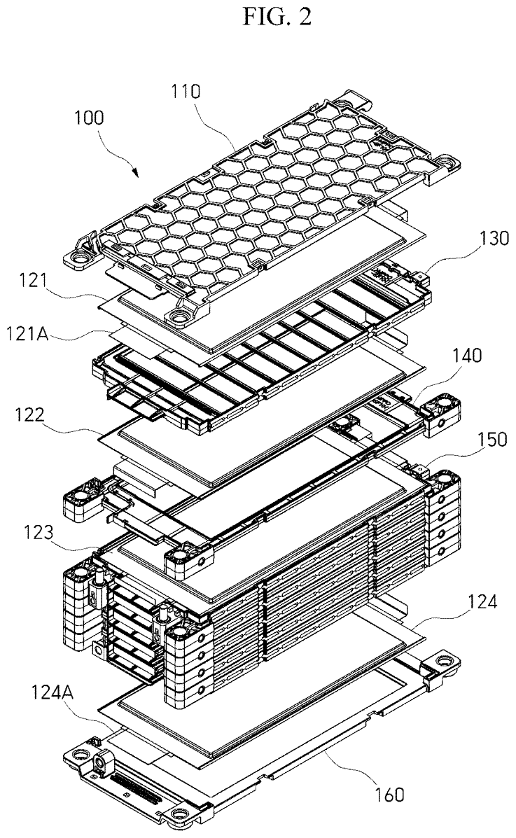

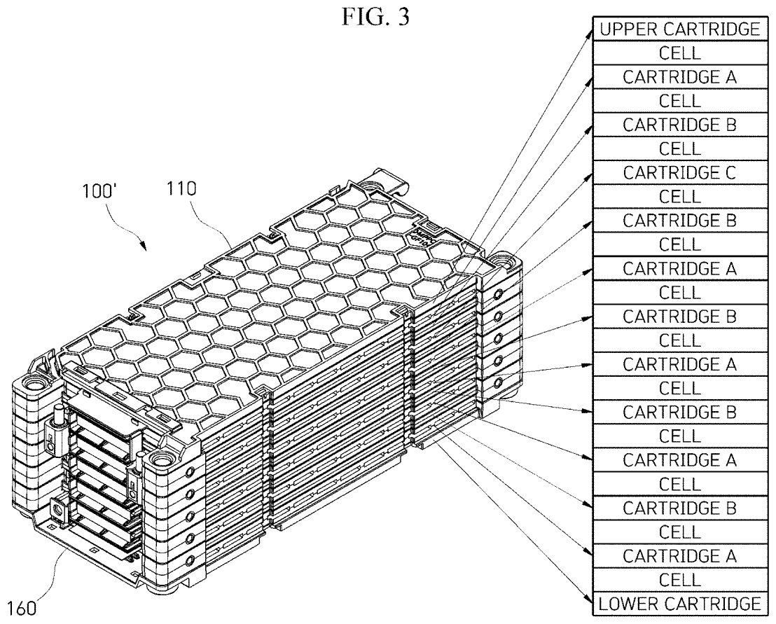

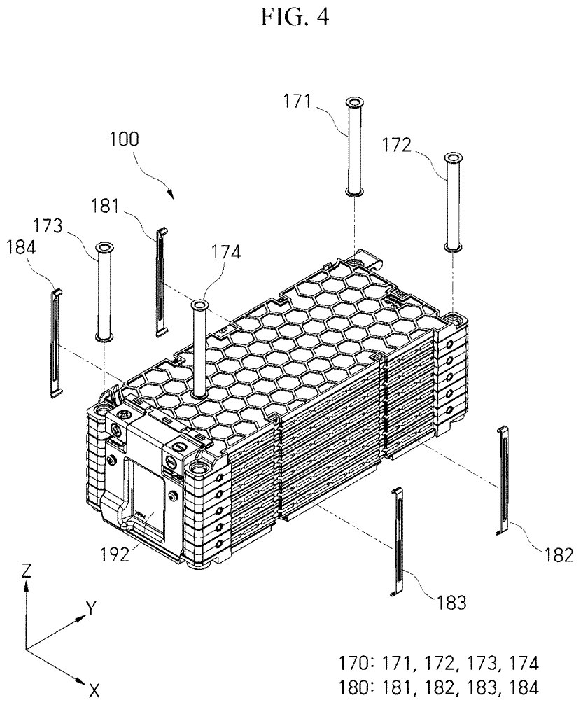

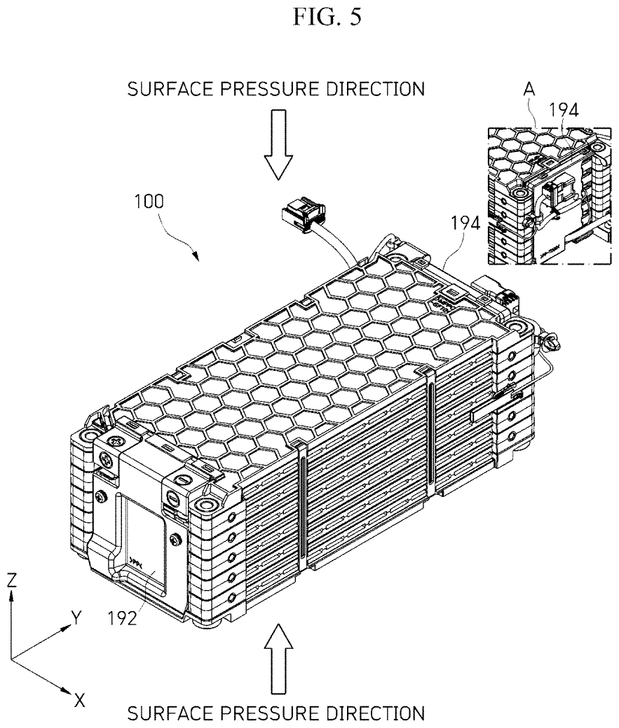

FIG. 2 is an exploded perspective view of a battery module assembly according to an exemplary embodiment of the present invention. FIG. 3 is a perspective view illustrating a state where elements illustrated in FIG. 2 are assembled. FIG. 4 is a perspective view illustrating elements for binding a plurality of stacked elements in a state where the elements illustrated in FIG. 2 are stacked. FIG. 5 is a perspective view illustrating a final appearance of a battery module assembly assembled by elements illustrated in FIG. 4.

Referring to FIGS. 2 to 5, a battery module assembly 100 according to an exemplary embodiment of the present invention may simultaneously provide an assembly structure and a mounting structure without external members such as upper and lower frame members 400 and 500 with a cell cover 310 inserted thereinto as in the related art, and thus, may decrease a total size, the number of elements, and an assembly cycle time.

To this end, the battery module assembly 100 according to an exemplary embodiment of the present invention may include a plurality of cartridges 110, 130, 140, 150, and 160 and a plurality of cells 121 to 124.

One cell may be disposed between the plurality of cartridges 110, 130, 140, 150, and 160, and thus, the battery module assembly 100 may have a structure where the plurality of cartridges 110, 130, 140, 150, and 160 and the plurality of cells 121 to 124 are sequentially stacked.

The plurality of cartridges 110, 130, 140, 150, and 160 may include an upper cartridge 110, a lower cartridge 160, and a plurality of middle cartridges 130 to 150 stacked therebetween, which are stacked with each cell therebetween.

The plurality of middle cartridges 130 to 150 may include a plurality of cartridge A 130, a plurality of cartridge B 140, and one cartridge C 150.

Although not so limited, in the present exemplary embodiment, the cartridge A and the cartridge B may be stacked between the cartridge C 150 and the upper cartridge 110, and the cartridge A and the cartridge B may be stacked between the cartridge C 150 and the lower cartridge 160.

In the battery module assembly 100 according to an exemplary embodiment of the present invention, each of the upper cartridge 110, the lower cartridge 160, and the cartridge C 150 may be provided as one, and each of the cartridge A 130 and the cartridge B 140 may be provided as five.

Additionally, as illustrated in FIG. 3, the battery module assembly 100 according to an exemplary embodiment of the present invention may further include a plurality of caulking members 170 (for example, 171 to 174) and a plurality of coupling members 180 (for example, 181 to 184), which bind a structure (100′ of FIG. 3) where the plurality of cartridges 110, 130, 140, 150, and 160 and the plurality of cells 121 to 124 are stacked.

The caulking pipe 170 may bind (fix or couple) a corner of the structure (100′ of FIG. 3) where the plurality of cartridges 110, 130, 140, 150, and 160 and the plurality of cells 121 to 124 are stacked. The coupling member 180 may bind (fix or couple) a side surface of the structure 100′ where the plurality of cartridges 110, 130, 140, 150, and 160 and the plurality of cells 121 to 124 are stacked.

The structure (100′ of FIG. 3) where the plurality of cartridges 110, 130, 140, 150, and 160 and the plurality of cells 121 to 124 are stacked may be bound (fixed or coupled) by the caulking pipe 170 and the coupling member 180, and thus, may be configured with the battery module assembly 100 of a unit module.

Both ends of each of the caulking pipes 171 to 174 may be processed in a T-shaped caulking structure, and thus, the caulking pipes 171 to 174 may bind (fix or couple) the battery module assembly 100 horizontally and vertically (in X, Y, and Z directions) at corners of the battery module assembly 100.

The coupling members 181 to 184 may each include both ends which are processed in a hook shape to be locked at both side surfaces of the battery module assembly 100, and the both ends may be respectively locked at a locking structure (for example, an upper hanging groove (81 of FIG. 8) and a lower hanging groove (83 of FIG. 8)) provided in a long side of the upper cartridge 110 and a long side of the lower cartridge 160.

Therefore, the coupling members 181 to 184 may bind (fix or couple) in a vertical direction (the Z direction) the cartridges 110, 130, 140, 150, and 160 and the cells 121 to 124 stacked on both side surfaces of the battery module assembly 100.

In FIGS. 4 and 5, reference numeral 192 refers to a front cover which covers a front surface of the battery module assembly 100.

In FIG. 5, reference numeral 194 refers to a rear cover which covers a rear surface of the battery module assembly 100, and ‘A’ illustrated at a right upper portion of FIG. 5 shows a state where the rear cover 194 is mounted on a rear surface of the battery module assembly 100.

In FIG. 3, a structure 100′ where a plurality of cartridges and a plurality of cells are stacked is illustrated. FIG. 3 illustrates an example where the cartridges of the structure 100′ are stacked in the order of an upper cartridge, a cartridge A, a cartridge B, a cartridge C, a cartridge B, a cartridge A, a cartridge B, a cartridge A, a cartridge B, a cartridge A, a cartridge B, a cartridge A, and a lower cartridge and each of the plurality of cells are stacked between two adjacent cartridges of the plurality of cartridges.

Hereinafter, the elements of the battery module assembly 100 according to an exemplary embodiment of the present invention will be described in detail.

Caulking Pipe 170

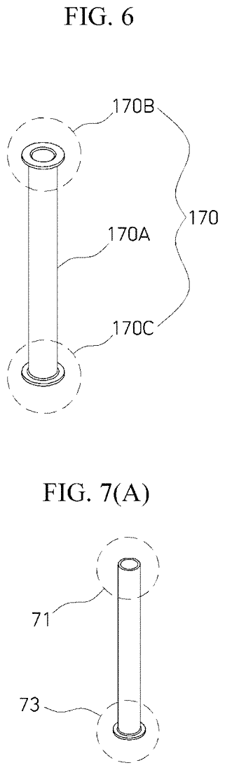

FIG. 6 is an enlarged view of the caulking pipe illustrated in FIG. 4.

Referring to FIG. 6, the caulking pipe may be inserted into a through-hole, provided in a corner of the battery module assembly 100 where the plurality of cartridges 110, 130, 140, 150, and 160 and the plurality of cells 121 to 124 are stacked, and may bind the corner of the battery module assembly 100.

In detail, the caulking pipe may include a cylindrical body 170A which extends by a height of the battery module assembly 100, and both end portions 170B and 170C of the body 170A may be configured to include a T-shaped caulking part (a caulking structure).

The cylindrical body 170A may be inserted into the through-hole provided in the corner of the battery module assembly 100 and may bind the corner of the battery module assembly 100 in the X direction and the Y direction.

Both end portions of the cylindrical body 170A may be processed in the T-shaped caulking structure in a state where the cylindrical body 170A is inserted into the through-hole provided in the corner of the battery module assembly 100, and thus, may bind the corner of the battery module assembly 100 in the Z direction.

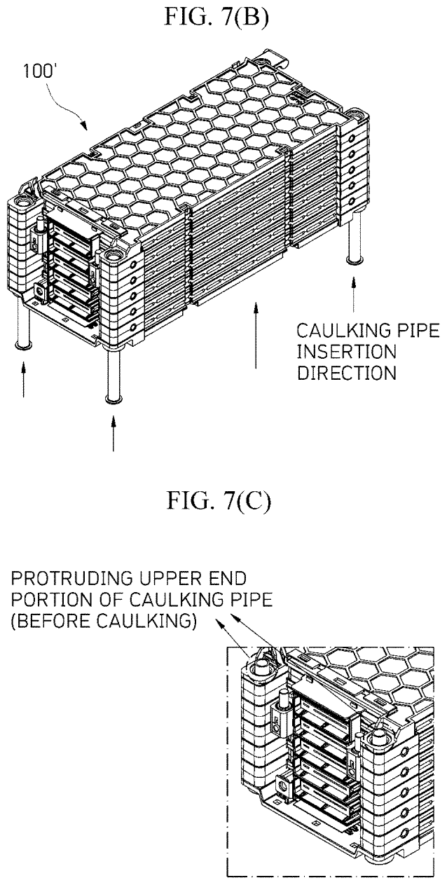

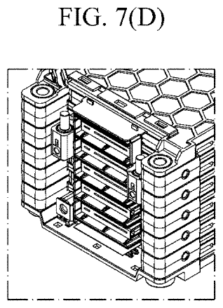

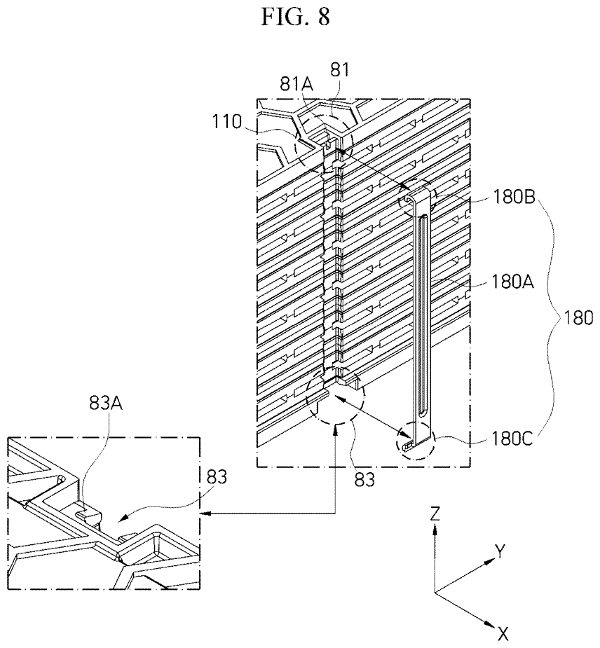

FIGS. 7(A), (B), (C), and (D) are diagrams schematically illustrating an assembly process of the battery module assembly based on the caulking pipe illustrated in FIG. 6.

As illustrated in FIG. 7 (A), a process of preparing a caulking pipe previously caulked in a T-shape at only one end portion of both end portions. Hereinafter, in step S110, a previously caulked end portion may be referred to as a lower end portion of the caulking pipe, and an end portion which is not caulked and has a pipe shape may be referred to as an upper end portion of the caulking pipe.

Subsequently, as illustrated in FIG. 7 (B), a caulking pipe where only a lower end portion 73 is caulked may be inserted into a through-hole provided in a corner of the structure 100′ where the plurality of cartridges 110, 130, 140, 150, and 160 and the plurality of cells 121 to 124 are stacked.

For example, only an upper end portion 71 which is not caulked may be first inserted into the through-hole. At this time, the insertion may be performed in a direction from a lower portion of the structure 100′ to an upper portion of the structure 100′ and may be performed until the insertion is no longer performed by a caulking structure of the lower end portion 73.

Subsequently, as illustrated in FIG. 7 (C), when the caulking pipe is fully inserted, the upper end portion of the caulking pipe may protrude upward with respect to the through-hole, and the upper end portion 71 of the protruding caulking pipe may be caulked by a pressing jig.

Subsequently, as illustrated in FIG. 7 (D), the corner of the structure 100′ may be bound by the caulking pipe in the X, Y, and Z directions in a process of caulking the upper end portion 71 of the caulking pipe, and the battery module assembly may be primarily assembled.

Simultaneously, the caulking pipe may bind four corners of the caulking pipe in the Z direction (the vertical direction) as well as the X and Y directions, and thus, may maintain a surface pressure of the battery module assembly.

As the surface pressure is maintained, swelling of each cell may be prevented, and a reduction in cell durability may be minimized.

Coupling Member 180

FIG. 8 is an enlarged view of the coupling member illustrated in FIG. 4.

Referring to FIG. 8, the above-described caulking pipe 170 may primarily bind the battery module assembly, and then, may secondarily bind the battery module assembly by using the coupling member 180.

The coupling member 180 may vertically bind the battery module assembly at a side surface of the battery module assembly.

The coupling member 180 may include a body 180A which extends by a length corresponding to a height of the battery module assembly (or the structure 100′), a hook part 180B which is provided at one end portion (hereinafter referred to as an upper end portion) of the body 180A, and an elastic protrusion portion 180C which is provided at the other end portion (hereinafter referred to as a lower end portion) of the body 180A.

The hook part 180B may be provided in a hook shape and may be fastened to the upper hanging groove 81 provided at a long side of the upper cartridge 110 of the battery module assembly.

The elastic protrusion portion 180C may be detachably fastened to the lower hanging groove 83 provided at a long side of the lower cartridge 160 of the battery module assembly.

In a fastening method, first, the elastic protrusion portion 180C provided at a lower end portion of the body 180A may be pushed into the lower hanging groove 83 so as to be hung on a hanging jaw 83A of the lower hanging groove 83 of the lower cartridge 160 in a state where the hook part 180A provided at an upper end portion of the body 180A is provided on the upper hanging groove 81 of the upper cartridge 110, and thus, fastening may be made.

The coupling member 180 may vertically bind the battery module assembly at the side surface of the battery module assembly. The coupling member 180 may help maintain a surface pressure of the battery module assembly. A material of the coupling member 180 may be an elastic material, and for example, may be a plastic material. The coupling member 180 may be manufactured by an injection molding process.

Upper Cartridge 110 and Lower Cartridge 160

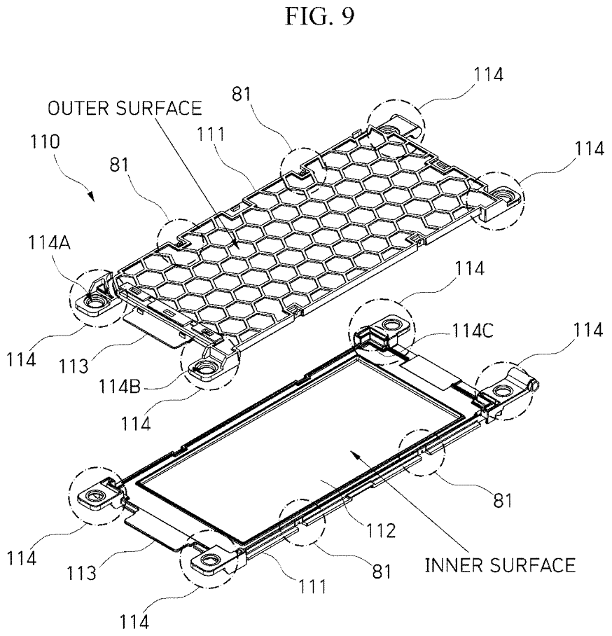

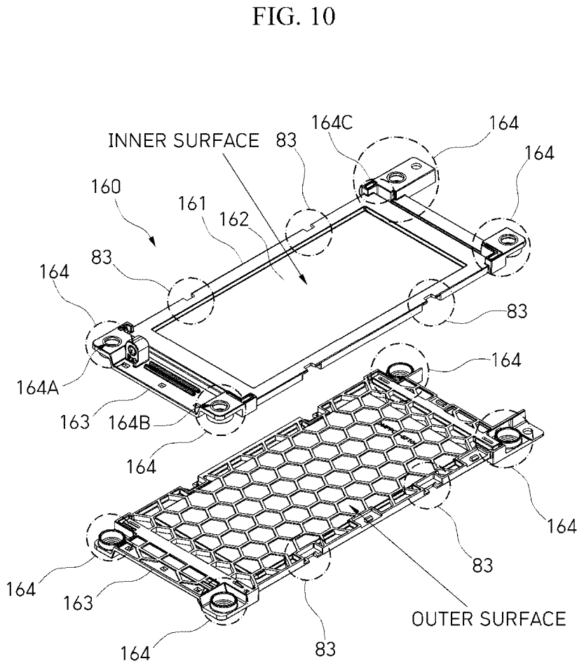

FIG. 9 is a perspective view illustrating an inner surface and an outer surface (or an upper surface) of an upper cartridge illustrated in FIG. 2; and FIG. 10 is a perspective view illustrating an inner surface (or a lower surface) and an outer surface (or an upper surface) of a lower cartridge illustrated in FIG. 2.

An upper portion of FIG. 9 illustrates a shape of an outer surface of the upper cartridge 110; and a lower portion of FIG. 9 illustrates a shape of an inner surface of the upper cartridge 110.

First, referring to FIG. 9, the upper cartridge 110 may be an element which is stacked on an uppermost end of the battery module assembly, and for example, may be configured to include a rectangular plate 111 and a corner portion 114 provided at a corner of the plate 111.

In order to minimize the outermost deformation of the battery module assembly, an outer surface of the plate 111 may be patterned in a honeycomb shape, as illustrated in FIG. 9.

An accommodating space 112 for fixing a position of a cell (121 of FIG. 2) stacked on a lower portion of the upper cartridge 110 and accommodating the cell may be provided in an inner surface of the plate 111. The accommodating space 112 may be provided to have the same size as that of the cell (121 of FIG. 2), for fixing the position of the cell (121 of FIG. 2) and accommodating the cell.

In order to prevent the exposure of an electrode part (an outermost electrode part) (121A of FIG. 2) of the cell (121 of FIG. 2), a cover member 113 covering the electrode part (121A of FIG. 2) may be provided at a short side of the plate 111. The cover member 113 may be provided to have a size for sufficiently covering the electrode part (121A of FIG. 2).

The corner portion 114 may include a corner portion 114 including a hole (an upper hole) 114A with the above-described caulking pipe 170 inserted thereinto. A bushing member 114B may be provided on an inner circumference surface of the hole (the upper hole) 114A.

The bushing member 114B may be provided between the hole (the upper hole) 114A and the caulking pipe 170 and may absorb an impact occurring in a process of processing an upper end portion of the caulking pipe 170 to have a caulking structure by using the pressing jig, thereby preventing the deformation of the upper cartridge and the other cartridges.

A material of the bushing member 114B may include any arbitrary material for absorbing a physical impact.

An upper coupling groove 81 to which the hook part 180B provided at an upper end of the above-described coupling member 180 is fastened may be provided at a long side of the plate 111. The description of FIG. 8 may be applied to a description of the upper coupling groove 81.

An upper portion of FIG. 10 illustrates a shape of an inner surface of the lower cartridge 160, and a lower portion of FIG. 10 illustrates a shape of an outer surface of the lower cartridge 160.

Referring to FIG. 10, the lower cartridge 160 may be an element which is stacked on a lowermost end of the battery module assembly, and for example, may be configured to include a rectangular plate 161 and a corner portion 164 provided at a corner of the plate 161.

An accommodating space 162 for fixing a position of a cell (124 of FIG. 2) stacked on an upper portion of the lower cartridge 160 and accommodating the cell (124 of FIG. 2) may be provided in an inner surface of the plate 161. The accommodating space 162 may be provided to have the same size as that of the cell (124 of FIG. 2), for accommodating the cell.

In order to minimize the outermost deformation of the battery module assembly, an outer surface of the plate 161 may be patterned in a honeycomb shape.

In order to prevent the exposure of an electrode part (an outermost electrode part) (124A of FIG. 2) of the cell 124 stacked on the plate 161, a cover member 163 covering the electrode part (124A of FIG. 2) of the cell may be provided at a short side of the plate 161.

A lower coupling groove 83 to which an elastic protrusion portion (180C of FIG. 8) provided at a lower end of the above-described coupling member 180 is fastened may be provided at a long side of the plate 161. The description of FIG. 8 may be applied to a description of the lower coupling groove 83.

The corner portion 164 may be configured to include a hole (a lower hole) 164A with the above-described caulking pipe 170 inserted thereinto. A bushing member 164B may be provided on an inner circumference surface of the hole (the lower hole) 164A.

The bushing member 164B may be provided between the hole (the upper hole) 164A and the caulking pipe 170 and may absorb an impact occurring in a process of processing an upper end portion of the caulking pipe 170 to have a caulking structure by using the pressing jig, thereby preventing the deformation of the lower cartridge 160 and the other cartridges. A material of the bushing member 164B may include any arbitrary material for absorbing a physical impact.

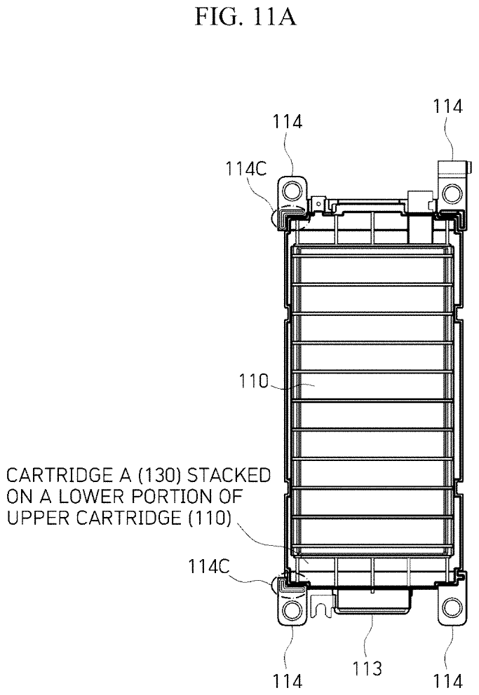

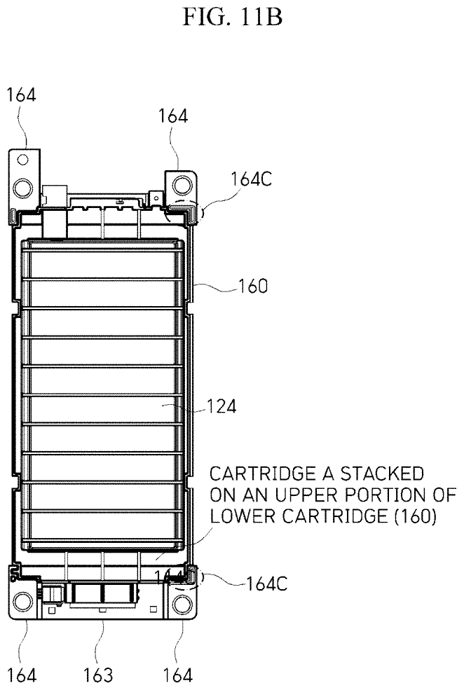

As illustrated in FIGS. 11A and 11B, each corner portion 114 of the upper cartridge 110 may be configured to include a ¬-shaped positioning jaw 114C for fixing a position of a cartridge A (130 of FIG. 2) stacked on a lower portion of each corner portion 114.

Similarly, each corner portion 164 of the lower cartridge 160 may be configured to include a ¬-shaped positioning jaw 164C for fixing a position of a cartridge A stacked on an upper portion of each corner portion 164.

Cartridge A 130

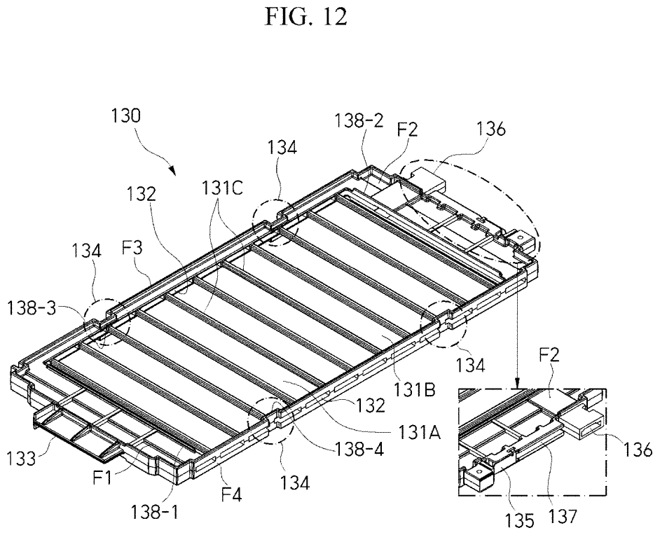

FIG. 12 is an enlarged view of a cartridge A illustrated in FIG. 2.

Referring to FIG. 12, a cartridge A 130 may have a rectangular shape and may include first to fourth frames F1 to F4.

The first and second frames F1 and F2 may configure a short side of the cartridge A 130, and the third and fourth frames F3 and F4 may configure a long side of the cartridge A 130. The cartridge A 130 may be manufactured by an injection molding process.

The cartridge A 130 may include a plurality of cooling channels 131A and 131B for cooling a cell. The plurality of cooling channels 131A and 131B may be provided in a direction from the third frame F3 to the fourth frame F4 or from the fourth frame F4 to the third frame F3.

In order to provide a cooling channel, the third and fourth frames F3 and F4 may include a plurality of air inflow ports 132 through which air flows in.

Each of the cooling channels may be a path which connect the air inflow ports 132 facing each other and may include a plurality of sidewalls 131C connecting an inner sidewall of the third frame F3 and an inner sidewall of the fourth frame F4, for forming the path. Based on a structure of each of the sidewalls 131C, the plurality of cooling channels 131A and 131B may be formed.

A positioning groove 134 where a body (180A of FIG. 8) of the above-described coupling member 160 is placed may be provided in each of both outer surfaces of the third frame F3 and the fourth frame F4.

A position at which the positioning groove 134 is provided may be a position corresponding to an upper hanging groove (81 of FIG. 8) of the upper cartridge 110 and a lower hanging groove (83 of FIG. 8) of the lower cartridge 160. That is, the positioning groove 134 may be disposed on a line which connects the upper hanging groove (81 of FIG. 8) of the upper cartridge 110 to the lower hanging groove (83 of FIG. 8) of the lower cartridge 160 in the vertical direction (the Z direction).

Moreover, a partition wall member 133 for preventing short circuits between electrode parts of vertically adjacent cells may be provided at one short side of the cartridge A 130, namely, the first frame F1.

Moreover, a bus bar 135 for sensing a voltage, a hole 136 with a temperature sensor inserted thereinto, and a shelter structure 137 for cell lead welding may be provided at the other short side of the cartridge A 130, namely, the second frame F2.

Moreover, a plurality of fixing members 138-1 to 138-4 may be provided on an inner surface of the cartridge A 130, for fixing a position of a cell. In detail, the plurality of fixing members 138-1 to 138-4 may include a plurality of first sidewalls 138_1 and 138_2, extending in parallel with a short side of the cartridge A 130 (i.e., the first and second frames F1 and F2), and a plurality of first sidewalls 138_3 and 138_4 formed by the positioning groove 134.

A position of a cell accommodated into (stacked on) the cartridge A 130 may be fixed by the fixing members 138-1 to 138-4.

Cartridge C 150

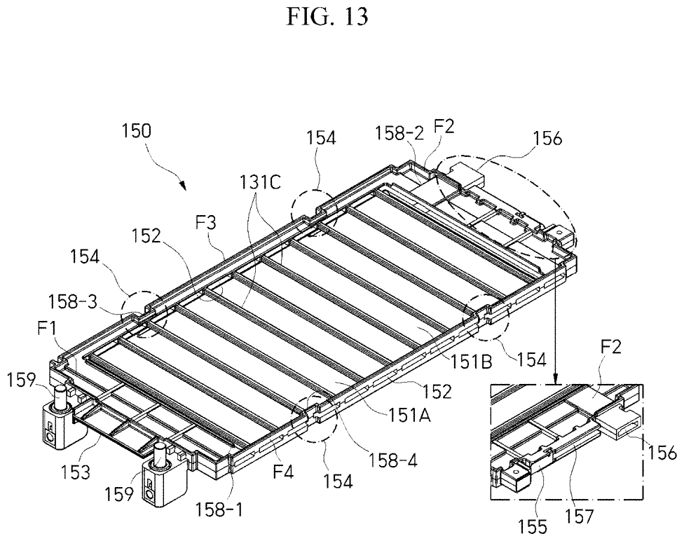

FIG. 13 is an enlarged view of a cartridge C illustrated in FIG. 2.

Referring to FIG. 13, except for that a cartridge C 150 includes positive (+) and negative (−) terminals 159, the cartridge C 150 may have a structure which is almost similar to the cartridge A 130.

The cartridge C 150 may have a rectangular shape and may include first to fourth frames F1 to F4. The first and second frames F1 and F2 may configure a short side of the cartridge C 150, and the third and fourth frames F3 and F4 may configure a long side of the cartridge C 150. The cartridge C 150 may be manufactured by an injection molding process.

The cartridge C 150 may include a plurality of cooling channels 151A and 151B for cooling a cell. In order to provide a cooling channel, a plurality of air inflow ports 132 through which air flows in may be provided in both side surfaces of the cartridge C 150 (i.e., the third and fourth frames F3 and F4).

Each of the cooling channels may be a path which connect the air inflow ports 132 facing each other and may include a plurality of sidewalls 151C connecting an inner sidewall of the third frame F3 and an inner sidewall of the fourth frame F4, for forming the path.

Based on a structure of each of the sidewalls 151C, the plurality of cooling channels 151A and 151B may be formed.

A positioning groove 154 where a body (180A of FIG. 8) of the above-described coupling member 160 is placed may be provided in each of both long sides of the cartridge C 150 (i.e., each of both outer surfaces of the third frame F3 and the fourth frame F4).

A position at which the positioning groove 154 is provided may be a position corresponding to an upper hanging groove (81 of FIG. 8) of the upper cartridge 110, a lower hanging groove (83 of FIG. 8) of the lower cartridge 160, and a positioning groove (134 of FIG. 12) of a cartridge A (130 of FIG. 12). That is, the positioning groove 154 may be disposed on a line which connects the upper hanging groove (81 of FIG. 8) of the upper cartridge 110, the lower hanging groove (83 of FIG. 8) of the lower cartridge 160, and the positioning groove 134 of the cartridge A 130 in the vertical direction (the Z direction).

Moreover, a partition wall member 153 for preventing short circuits between electrode parts of vertically adjacent cells may be provided at one short side of the cartridge C 150, namely, the first frame F1.

Moreover, a bus bar 155 for sensing a voltage, a hole 156 with a temperature sensor inserted thereinto, and a shelter structure 157 for cell lead welding may be provided at the other short side of the cartridge C 150, namely, the second frame F2.

Moreover, a plurality of fixing members may be provided on an inner surface of the cartridge C 150, for fixing a position of a cell. The plurality of fixing members may include a plurality of first sidewalls 158_1 and 158_2, extending in parallel with short sides F1 and F2 of the cartridge C 150, and a plurality of second sidewalls 158_3 and 158_4 formed by the positioning groove 154. A position of a cell accommodated into (stacked on) the cartridge C 150 may be fixed by the fixing members 158-1 to 158-4.

Moreover, as described above, unlike the cartridge A 130, the cartridge C 150 may include the positive (+) and negative (−) terminals 159, and the positive (+) and negative (−) terminals 159 may be provided at an outer sidewall of the first frame F1 in a direction vertical to a top surface of the first frame F1.

Cartridge B 140

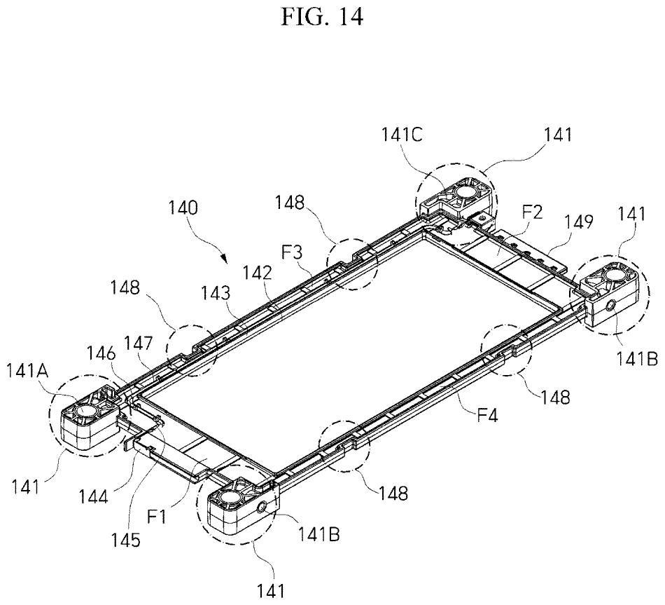

FIG. 14 is an enlarged view of a cartridge B illustrated in FIG. 2.

Referring to FIG. 14, when seen in a direction from an upper portion to a lower portion, the cartridge B 140 may be configured in a rectangular ring shape where a center portion is empty.

A corner portion 141 including a hole (or a center hole) 141A may be provided at a corner portion of the cartridge B 140. As illustrated in FIG. 2, when a plurality of cartridges are stacked with one cell therebetween, the hole (or the center hole) 141A provided at the corner portion 141 of the cartridge B 140 may communicate with a hole (or a center hole) 114A provided at a corner portion (114 of FIG. 9) of the upper cartridge 110 and a hole 164A provided at a corner portion (164 of FIG. 10) of the lower cartridge 160, thereby forming a through-hole with a caulking pipe (170 of FIG. 6) inserted thereinto.

A bushing member (not shown) may be provided on an inner circumference surface of the hole (the upper hole) 141A. The bushing member may be provided between the hole (the upper hole) 141A and the caulking pipe 170 and may absorb an impact occurring in a process of processing an upper end portion of the caulking pipe 170 to have a caulking structure by using the pressing jig or in a process of inserting the caulking pipe 170, thereby preventing the deformation of the cartridges.

Moreover, the cartridge B 140 may include four frames (for example, first to fourth frames) F1 to F4 connecting four corner portions 141. The first and second frames F1 and F2 may configure a short side of the cartridge B 140 and may configure long sides of the third and fourth frames F3 and F4.

A border of the cartridge A 130 and a border of the cartridge C 150 may be stacked on the four frames F1 to F4.

When the border of the cartridge A 130 and the border of the cartridge C 150 are stacked, the corner portion 141 may be configured to include a ¬-shaped positioning jaw 141C, for fixing positions of the cartridge A 130 and the cartridge C 150.

Moreover, the cartridge B 140 may include a positioning part 142 for accommodating a cell (122 of FIG. 2) and a side surface portion 143. The positioning part 142 may be an element where at least a portion of a cell is placed and may be provided to correspond to a lower portion of the cell (122 of FIG. 2). For example, when a lower portion of cell (122 of FIG. 2) is provided to be flat, a top surface of the positioning part 142 may be provided to be flat.

The side surface portion 143 may be provided to stand in a direction vertical to a border of the positioning part 142. When the cell (122 of FIG. 2) is accommodated into the cartridge B 140, the side surface portion 143 may be disposed on a side surface of the cell to cover a side surface of the cell (122 of FIG. 2) and to fix a position of the cell (122 of FIG. 2).

Moreover, the cartridge B 140 may include a bus bar 144 for sensing a voltage. The bus bar 144 may be buried into a first buried groove 145 provided in a first frame F1 of the cartridge B 140. In this case, a portion of the bus bar 144 may be exposed at a portion on a side surface of the first frame F1, and the other portion may be buried into the first buried groove 145.

Moreover, the cartridge B 140 may include a sensing wire 146 for transferring a voltage sensing result based on the bus bar 144. The cartridge B 140 may include a second buried groove 147 where the sensing wire 146 is buried, for including the sensing wire 146.

The second buried groove 147 may be provided in the first to third frames F1 to F3. A portion of the second buried groove 147 may be provided in the first frame F1 and may communicate with the first buried groove 145. Based on the first and second buried grooves 145 and 147, the sensing wire 146 may be disposed along a portion of a border of the cartridge B 140.

Moreover, the cartridge B 140 may include a positioning groove 148 where a body (180A of FIG. 8) of the above-described coupling member 160 is placed.

The positioning groove 148 may be provided in an outer surface of each of the third and fourth frames F3 and F4 configuring a long side so as to bind the battery module assembly at a side surface of the battery module assembly.

Moreover, the cartridge B 140 may include a partition wall 149, for preventing short circuits between an electrode part of a cell disposed at an upper portion of the cartridge B 140 and an electrode part of a cell disposed at a lower portion of the cartridge B 140.

The partition wall member 140 may extend from a side surface of the second frame F2 to have a size for covering an electrode part of a cell.

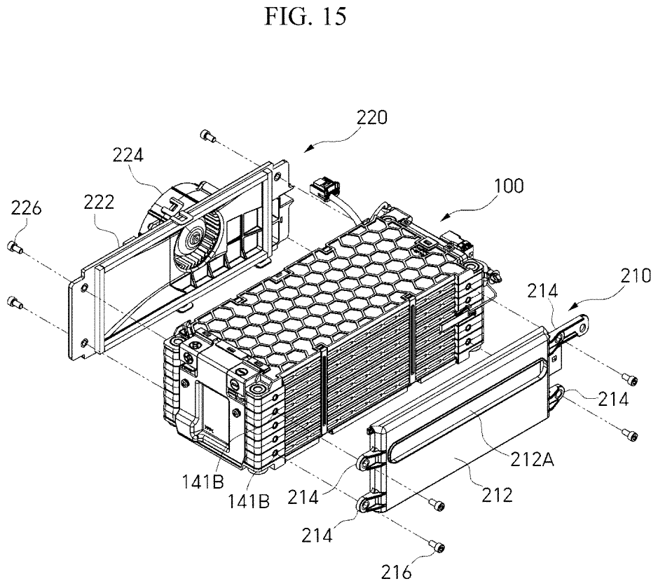

FIGS. 15 to 17 are diagrams for describing a structure where a battery module assembly according to an exemplary embodiment of the present invention is mounted on a case.

When a battery module assembly is completed by assembling a plurality of cartridges with each cell therebetween by using a caulking pipe (170 of FIG. 6) and a coupling member (180 of FIG. 180), an operation of mounting the battery module assembly on a case may be performed.

First, referring to FIG. 15, when an assembly of a battery module assembly 100 is completed by using the caulking pipe (170 of FIG. 6) and the coupling member (180 of FIG. 180), a side cover member 120 covering both side surfaces of the battery module assembly 100 may be assembled.

A plurality of side cover members 210 and 220 may include a first side cover member 210 and a second side cover member 220.

The first side cover member 210 may be coupled to one side surface of the battery module assembly 100 to cover the one side surface of the battery module assembly 100.

The first side cover member 210 may include a rectangular plate 212 which covers one side surface of the battery module assembly 100 and a protrusion portion 214 which protrudes from a short side of the plate 212. The protrusion portion 214 may include a fastening hole through which a fastening part 216 passes.

The fastening part 216 may pass through the fastening hole of the protrusion portion 214 and may be fastened to a fastening hole (141B of FIGS. 14 and 15) provided in a side surface of a corner portion 141 of a cartridge B 140 to fasten the first side cover member 210 to one side surface of the battery module assembly 100.

The fastening part 216 may be, for example, a bolt member. A fastening method may be a bolt coupling method.

The plate 212 may include a rectangular hole 212A which is long provided along a long side of the plate 212, and the rectangular hole 212A may act as a path through which air flows.

That is, the rectangular hole 212A may act as a path of air flowing in through an air inflow port (132 of FIG. 12) of a stacked cartridge A 130 and an air inflow port (152 of FIG. 13) of a cartridge C 150, and in terms of acting as a path of air, the first side cover member 210 may act as a duct of the battery module assembly.

The second side cover member 220 may be coupled to the other side surface of the battery module assembly 100 to cover the other side surface of the battery module assembly 100.

The second side cover member 220 may include a rectangular plate 222 which covers the other side surface of the battery module assembly 100 and a cooling fan 224 provided on the plate 222.

The plate 222 may include a discharge port which discharges air to the outside on the basis of an operation of the cooling fan 224, for cooling heat of the battery module assembly 100, and the cooling fan may be mounted on an outer surface of the plate 222 to cover the discharge port.

The plate 222 may include a fastening hole through which the fastening part 226 passes, so as to be coupled to the other side surface of the battery module assembly 100.

The fastening hole may be provided near a corner of the plate 222. The fastening part 226 may pass through the fastening hole provided near the corner of the plate 222 and may be fastened to the fastening hole (141B of FIGS. 14 and 15) provided in the side surface of the corner portion 141 of a cartridge B 140 to fasten the second side cover member 220 to the other side surface of the battery module assembly 100.

When the side cover member is fastened to both side surfaces of the battery module assembly 100, an operation of accommodating (fixing or mounting) the battery module assembly 100, fastened to the side cover member at both side surfaces thereof, into a case may be performed.

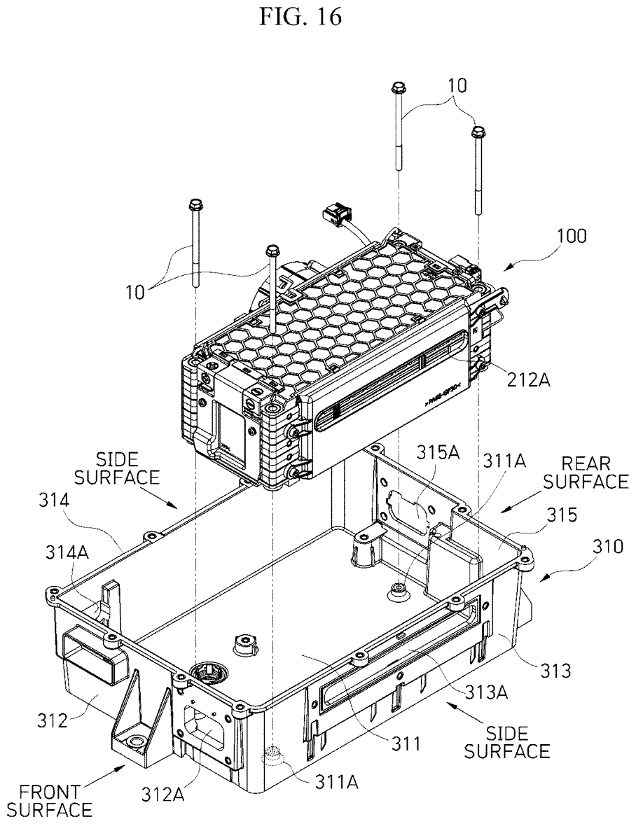

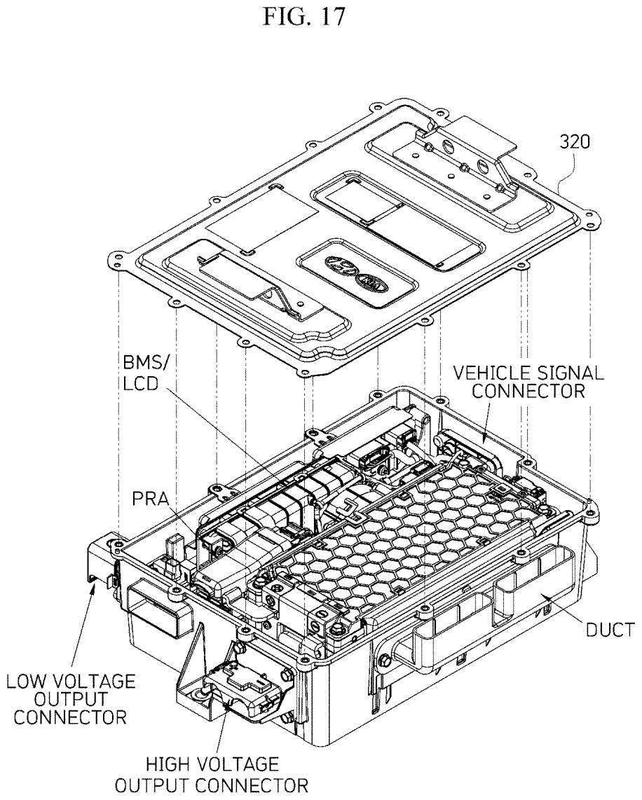

In detail, referring to FIGS. 16 and 17, the case with the battery module assembly 100 mounted (accommodated) thereon may include a lower case 310 and an upper case (320 of FIG. 17).

The lower case 310, as illustrated in FIG. 16, may include a bottom member 311 which is approximately rectangular in shape and four sidewall members (for example, first to fourth sidewall members) 312 to 315 which extend from a border of the bottom member 311 in an approximately vertical direction. An accommodating space, where the battery module assembly 100 fastened to the side cover members 212 and 222 is mounted (accommodated), may be provided based on the elements 311 to 315.

A plurality of protrusion portions 311A protruding in an upward direction may be provided in the bottom member 311, and each of the protrusion portions 311A may include a fastening hole fastened to an end portion of a long bolt 10.

The long bolt 10 may pass through a caulking pipe (170 of FIG. 6) provided at a corner of the battery module assembly 100, and an end portion of the long bolt 10 protruding in a downward direction with respect to the battery module assembly 100 may be fastened to a fastening hole of the protrusion portion 311A, whereby the battery module assembly 100 may be accommodated into an internal space of the lower case 310 and may be fixed not to move.

The first sidewall member 312 may be an element which configures a front surface of the case, and a hole 312A, which connects a high voltage output connector to a wire for transferring a high voltage (or a high voltage converted from a voltage output from the battery module assembly 100) output from the battery module assembly 100, may be provided in the first sidewall member 312.

The second sidewall member 313 may be an element which configures one side surface of the case and may include a long-direction hole 313A communicating with a long-direction hole 212A provided in a side cover member (212 of FIG. 15) fastened to a side surface of the battery module assembly 100.

The third sidewall member 314 may be an element which configures the other side surface of the case and may include a hole 312A which connects a low voltage output connector to a wire for transferring a low voltage (or a low voltage converted from a voltage output from the battery module assembly 100) output from the battery module assembly 100.

The fourth sidewall member 315 may be an element which configures a rear surface of the case and may include a hole 315A which connects a vehicle signal connector to a wire for transferring a vehicle signal input/output to/from the battery module assembly 100.

When accommodating of the battery module assembly 100 into an inner portion of the lower case 310 is completed, as illustrated in FIG. 17, electronic parts (for example, a battery management system (BMS), a low voltage dc-to-dc converter (LDC), a part for outputting a low voltage, a part for outputting a high voltage, and a part for transmitting and receiving a vehicle signal) may be accommodated into a spare space other than a space, occupied by the battery module assembly 100, of an internal space of the lower case 310, and then, the upper case 320 may be coupled to the lower case 310.

Subsequently, the high voltage output connector, the low voltage output connector, the vehicle signal connector, and the duct may be respectively fastened to the holes provided in the sidewall members of the lower case by using a bolt fastening method, thereby completing an operation of mounting the battery module assembly on the case.

As described above, according to the exemplary embodiments of the present invention, the battery module assembly may be assembled with a plurality of stacked cartridges by using a caulking pipe, and the battery module assembly may be mounted on the case by using a fastening member (for example, a long bolt) passing through an internal hole of the caulking pipe.

Therefore, an assembly operation and a mounting operation each performed on the battery module assembly may be integrated by the caulking pipe, and thus, a total volume, the number of parts, and a battery module assembly cycle time may be largely reduced.

According to the exemplary embodiments of the present invention, an assembly structure of the battery module assembly may be provided by using the caulking pipe, thereby reducing a total assembly cycle time of the battery module assembly.

Moreover, without an upper/lower frame member, the battery module assembly may be assembled by using the caulking pipe, thereby solving a problem where a handwork of unfolding the partition wall part of the lower frame member before inserting a cell cover surrounding battery cells into the lower frame member is performed several or tens times due to a bending phenomenon of a partition wall part of the lower frame member in the related art.

Moreover, a surface pressure may be secured by using the caulking pipe and a coupling member without an external member.

Moreover, the assembly structure and a mounting structure of the battery module assembly may be provided by using the caulking pipe, thereby reducing the number of elements and a size of the battery module assembly.

It will be apparent to those skilled in the art that various modifications and variations can be made in the present invention without departing from the spirit and scope of the inventive concepts. Thus, it is intended that the present invention cover the modifications and variations of the disclosed embodiments provided they come within the scope of the appended claims and their equivalents.

What is claimed is:

1. A battery module assembly comprising:
a plurality of cells;
a plurality of cartridges stacked in a vertical direction with a corresponding cell therebetween; and
a caulking pipe inserted into a through-hole provided in a corner of each of the stacked plurality of cartridges, for assembling the stacked plurality of cartridges.

2. The battery module assembly of claim 1, wherein the through-hole is formed by passing through, in a vertical direction, a corner of each of some of the stacked plurality of cartridges.

3. The battery module assembly of claim 1, wherein the caulking pipe comprises:
a body having a cylindrical shape; and
a T-shaped caulking part provided at each of both ends of the body.

4. The battery module assembly of claim 1, wherein the plurality of cartridges comprise:
an upper cartridge stacked on an uppermost end, the upper cartridge including an upper hole forming the through-hole at a corner thereof;
a lower cartridge stacked on a lowermost end, the lower cartridge including a lower hole forming the through-hole at a corner thereof; and
a plurality of middle cartridges stacked between the upper cartridge and the lower cartridge, each of the plurality of middle cartridges including a center hole forming the through-hole at a corner thereof.

5. The battery module assembly of claim 4, further comprising a bushing member provided on an inner circumference surface of each of the upper hole and the lower hole.

6. The battery module assembly of claim 4, wherein each of the upper cartridge and the lower cartridge comprises:
a plate including an outer surface patterned in a honeycomb shape; and
a corner portion including a hole at a corner of the plate.

7. The battery module assembly of claim 4, wherein:
the plurality of middle cartridges comprise a cartridge B having a rectangular ring shape where a center portion thereof is empty; and
the cartridge B comprises:
four corner portions each including the middle hole;
a first frame and a second frame connecting the four corner portions and configuring a short side of the cartridge B; and
a third frame and a fourth frame configuring a long side of the cartridge B.

8. A battery module assembly comprising:
a plurality of cells;
a plurality of cartridges stacked in a vertical direction with a corresponding cell therebetween;
a caulking pipe inserted into a through-hole provided in a corner of each of the stacked plurality of cartridges to bind the stacked plurality of cartridges in a horizontal direction and the vertical direction; and
a coupling member coupled to a side surface of each of the stacked plurality of cartridges to bind the stacked plurality of cartridges in the vertical direction.

9. The battery module assembly of claim 8, wherein the coupling member comprises:
a body extending by a length corresponding to a height of the stacked plurality of cartridges;
a hook part provided at one end portion of the body and fastened to an upper hanging groove provided at a long side of an upper cartridge placed at an uppermost end among the plurality of cartridges; and
an elastic protrusion portion provided at the other end portion of the body and detachably fastened to a lower hanging groove provided at a long side of a lower cartridge placed at a lowermost end among the plurality of cartridges.

10. The battery module assembly of claim 9, wherein:
the plurality of cartridges comprise a plurality of middle cartridges stacked between the upper cartridge and the lower cartridge; and
each of the plurality of middle cartridges comprises a positioning groove where the body is placed on an outer surface thereof.

11. The battery module assembly of claim 8, wherein:
the plurality of cartridges comprise:
an upper cartridge stacked on an uppermost end, the upper cartridge including an upper hole at a corner thereof;
a lower cartridge stacked on a lowermost end, the lower cartridge including a lower hole at a corner thereof; and
a plurality of cartridges B stacked between the upper cartridge and the lower cartridge, each of the plurality of middle cartridges B including a center hole at a corner thereof; and
the through-hole is formed based on communication between the upper hole, the lower hole, and the center hole.

12. The battery module assembly of claim 11, further comprising a positioning groove provided in a long side of each of the upper cartridge, the lower cartridge, and the plurality of middle cartridges, wherein the coupling member is placed in the positioning groove.

13. The battery module assembly of claim 11, wherein each of the plurality of cartridges B comprises:
a bus bar sensing a voltage; and
a buried groove where the bus bar is buried.

14. The battery module assembly of claim 11, wherein the plurality of cartridges further comprise:
a cartridge A having a rectangular shape, including a long side and a short side, and including a plurality of air inflow ports provided at the long side for forming a plurality of cooling channels; and
a cartridge B having a rectangular shape, including a long side and a short side, and including a plurality of air inflow ports provided at the long side for forming a plurality of cooling channels.

15. The battery module assembly of claim 14, further comprising a positioning groove provided in a long side of each of the cartridge A and the cartridge C, wherein the coupling member is placed in the positioning groove.

16. A method of manufacturing a battery module assembly, the method comprising:
stacking a plurality of cartridges in a vertical direction with a corresponding cell therebetween;
inserting a caulking pipe into a through-hole provided in a corner of each of the stacked plurality of cartridges to bind the stacked plurality of cartridges in a horizontal direction and the vertical direction; and
fastening a side surface of each of the stacked plurality of cartridges to a coupling member for binding the stacked plurality of cartridges in the vertical direction.

17. The method of claim 16, wherein the inserting of the caulking pipe comprises:
preparing a caulking pipe having a caulking structure where one end portion thereof is caulked in a T-shape;
inserting the other end portion of the caulking pipe into the through-hole; and
when the insertion of the caulking pipe is completed, processing the other end portion exposed at an upper portion of the through-hole by using a pressing jig to have a T-shaped caulking structure.

18. The method of claim 16, wherein the fastening of the coupling member comprises:
hanging a hook part, provided at an upper end portion of the coupling member, on a hanging jaw provided in an upper hanging groove of an upper cartridge stacked on an uppermost end among the plurality of cartridges; and
pushing an elastic protrusion portion, provided at a lower end portion of the coupling member, into a lower hanging groove to be hung on a hanging jaw of a lower hanging groove of a lower cartridge stacked on a lowermost end among the plurality of cartridges, thereby fastening the coupling member to a side surface of each of the stacked plurality of cartridges.
